(19) United States
(12) Patent Application Publication
(10) Pub. No.: US 2024/0046264 A1
(43) Pub. Date: Feb. 8, 2024

(54) METHOD, APPARATUS, AND RECORDING MEDIUM

(71) Applicant: Panasonic Intellectual Property Corporation of America, Torrance, CA (US)

(72) Inventors: Naohisa NISHIDA, Osaka (JP); Kakuya YAMAMOTO, Hyogo (JP); Yuji UNAGAMI, Osaka (JP); Yuuki Hirose, Osaka (JP); Ayaka NAKASAKA, Osaka (JP); Motoji OHMORI, Osaka (JP); Junji MICHIYAMA, Fukuoka (JP)

(21) Appl. No.: 18/382,154

(22) Filed: Oct. 20, 2023

Related U.S. Application Data
(63) Continuation of application No. PCT/JP2022/017945, filed on Apr. 15, 2022.
(60) Provisional application No. 63/178,144, filed on Apr. 22, 2021.

(51) Int. Cl. G06Q 20/38

(52) U.S. Cl. CPC G06Q 20/389; G06Q 2220/10

(57) ABSTRACT

A method includes: acquiring transaction data that includes value information regarding a value to be transferred from a second user to a first user; executing a first smart contract recorded in a first blockchain by recording the transaction data in the first blockchain; and executing a second smart contract recorded in a second blockchain different from the first blockchain based on the first smart contract. The second smart contract is a smart contract for transferring at least a portion of the value to be transferred from the second user to the first user, from a first account held by the first user to a third account held by a third user.

### CROSS REFERENCE TO RELATED APPLICATIONS

This is a continuation application of PCT International Application No. PCT/JP2022/017945 filed on Apr. 15, 2022, designating the United States of America, which is based on and claims priority of U.S. Provisional Patent Application No. 63/178144 filed on Apr. 22, 2021.The entire disclosures of the above-identified applications, including the specifications, drawings and claims are incorporated herein by reference in theft entirety.

### FIELD

The present disclosure relates to a method, an apparatus, and a recording medium.

### BACKGROUND

Conventionally, smart contract technology that automatically executes processing operations from checking the terms and conditions of a contract to executing the contract on a blockchain is used. For example, Patent Literature (PTL) 1 discloses a method for automatically executing a trade transaction procedure by using smart contract technology.

### CITATION LIST

Patent Literature

PTL 1: WO 2019/003414

### SUMMARY

### Technical Problem

It is an object of the present disclosure to provide a method and the like with which it is possible to jointly execute two types of value transfer smart contracts.

### Solution to Problem

A method according to an aspect of the present disclosure is a method including: acquiring transaction data that includes value information regarding a value to be transferred from a second user to a first user; executing a first smart contract recorded in a first blockchain by recording the transaction data in the first blockchain; and executing a second smart contract recorded in a second blockchain different from the first blockchain based on the first smart contract, wherein the second smart contract is a smart contract for transferring at least a portion of the value to be transferred from the second user to the first user, from a first account held by the first user to a third account held by a third user.

General and specific aspects disclosed above may be implemented using a system, a device, an integrated circuit, a computer program, or a computer-readable recording medium such as a CD-ROM, or any combination of systems, devices, integrated circuits, computer programs, or recording media.

### ADVANTAGEOUS EFFECTS

According to the present disclosure, it is possible to jointly execute two types of value transfer smart contracts.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing an example of a configuration of a management system according to Embodiment 1.

FIG. 2 is a diagram showing an example of a configuration of an aggregator apparatus according to Embodiment 1.

FIG. 3 is a table showing an example of a configuration of public data information.

FIG. 4 is a table showing an example of a configuration of account information.

FIG. 5 is a table showing an example of a configuration of non-public data information.

FIG. 6 is a diagram showing an example of a configuration of a purchaser apparatus according to Embodiment 1.

FIG. 7 is a diagram showing an example of a configuration of a provider apparatus according to Embodiment 1.

FIG. 8 is a sequence diagram illustrating an example of data acquiring processing performed by the management system according to Embodiment 1.

FIG. 9 is a sequence diagram illustrating an example of processing of storing distributed ledger information in a distributed ledger, performed by the management system according to Embodiment 1.

FIG. 10 is a sequence diagram illustrating an example of processing of storing smart contracts in distributed ledgers, performed by the management system according to Embodiment 1.

FIG. 11 is a sequence diagram illustrating an example of data buy-sell processing performed by the management system according to Embodiment 1.

FIG. 12 is a sequence diagram illustrating an example of data buy-sell processing performed by a management system according to Embodiment 2.

FIG. 13 is a sequence diagram illustrating an example of data buy-sell processing performed by a management system according to Embodiment 3.

FIG. 14 is a sequence diagram illustrating an example of data buy-sell processing performed by a management system according to Embodiment 4.

### DESCRIPTION OF EMBODIMENTS

A method according to an aspect of the present disclosure is a method including: acquiring transaction data that includes value information regarding a value to be transferred from a second user to a first user; executing a first smart contract recorded in a first blockchain by recording the transaction data in the first blockchain; and executing a second smart contract recorded in a second blockchain different from the first blockchain based on the first smart contract, wherein the second smart contract is a smart contract for transferring at least a portion of the value to be transferred from the second user to the first user, from a first account held by the first user to a third account held by a third user.

According to the aspect of the present disclosure, two smart contracts for executing two types of data value transfer contracts, the two smart contracts corresponding to the two types of data value transfer contracts, are recorded separately in two different blockchains. One of the two types of data value transfer contracts is a payment contract for paying a value for data from the second user to the first user that is generated when the second user purchases the data. The other one of the two types of data value transfer contracts is a payment contract for paying at least a portion of the value for the data from the first user to the third user that is generated when the second user purchases the data. As described above, the two types of data value transfer contracts are a contract between the first user and the second user and a contract between the first user and the third user, and thus combinations of users who are the parties involved in the contracts are different. That is, by separately recording two smart contracts in two different blockchains, it is possible to prevent a user other than the parties involved in a contract from knowing a smart contract that corresponds to the contract. As described above, even when two smart contracts are separately recorded in two different blockchains, the two smart contracts are jointly executed, and it is therefore possible to jointly execute the two types of contracts. Accordingly, for example, in the case where the third user is a data provider that provides data, and the first user is a mediator for buying and selling the data between the third user and the second user, when a value for the data is transferred from the second user to the first user, at least a portion of the value for the data is also automatically transferred from the first user to the third user.

Also, the executing of the first smart contract may include: generating first execution transaction data for executing the second smart contract; and the executing of the second smart contract includes recording the first execution transaction data generated in the second blockchain.

With this configuration, the second smart contract can be executed by executing the first smart contract.

Also, the executing of the first smart contract may include: generating second execution transaction data for executing a third smart contract recorded in a third blockchain different from the first blockchain and the second blockchain; and executing the third smart contract by recording the second execution transaction data in the third blockchain.

With this configuration, the third smart contract can be executed by executing the first smart contract.

Also, the executing of the third smart contract may include: identifying the second smart contract that is a smart contract correlated with the first smart contract; generating first execution transaction data for executing the second smart contract; and the executing of the second smart contract includes recording the first execution transaction data in the second blockchain.

With this configuration, the third smart contract can be executed by executing the first smart contract, and the second smart contract can be executed by executing the third smart contract.

Also, the executing of the first smart contract may include: transferring the value to be transferred from the second user to the first user, from a second account held by the second user to the first account held by the first user.

With this configuration, by executing the first smart contract, the second user can pay the value to the first user.

Also, the first smart contract may include an identifier for identifying the second smart contract. The executing of the first smart contract may include: identifying the second smart contract that is correlated with the first smart contract by referencing the identifier; and generating the first execution transaction data after the identifying.

With this configuration, the second smart contract that is executed jointly with the first smart contract can be easily identified.

Also, the executing of the first smart contract may include: determining whether a first apparatus holds the second blockchain, the first apparatus holding distributed ledgers that use blockchains, and executing the second smart contract when the first apparatus is determined to hold the second blockchain.

With this configuration, the first apparatus that holds the second blockchain can execute the second smart contract.

Also, the value to be transferred from the second user to the first user may be a value for data that is provided from the third user. The data may be stored publicly in association with a converted identifier obtained as a result of converting an identifier for identifying the third user. The identifier for identifying the third user may be stored privately in association with the converted identifier.

With this configuration, the identifier of the third user can be managed, with the identifier of the third user being stored privately and in association with the data.

Also, an apparatus according to an aspect of the present disclosure includes: an acquirer that acquires transaction data that includes value information regarding a value to be transferred from a second user to a first user; and an executor that (i) executes a first smart contract recorded in a first blockchain by recording the transaction data in the first blockchain and (ii) executing a second smart contract recorded in a second blockchain different from the first blockchain based on the first smart contract, wherein the second smart contract is a smart contract for transferring at least a portion of the value to be transferred from the second user to the first user, from a first account held by the first user to a third account held by a third user.

According to the aspect of the present disclosure, two smart contracts for executing two types of data value transfer contracts, the two smart contracts corresponding to the two types of data value transfer contracts, are recorded separately in two different blockchains. One of the two types of data value transfer contracts is a payment contract for paying a value for data from the second user to the first user that is generated when the second user purchases the data. The other one of the two types of data value transfer contracts is a payment contract for paying at least a portion of the value for the data from the first user to the third user that is generated when the second user purchases the data. As described above, the two types of data value transfer contracts are a contract between the first user and the second user and a contract between the first user and the third user, and thus combinations of users who are the parties involved in the contracts are different. That is, by separately recording two smart contracts in two different blockchains, it is possible to prevent a user other than the parties involved in a contract from knowing a smart contract that corresponds to the contract. As described above, even when two smart contracts are separately recorded in two different blockchains, the two smart contracts are jointly executed, and it is therefore possible to jointly execute the two types of contracts. Accordingly, for example, in the case where the third user is a data provider that provides data, and the first user is a mediator for buying and selling the data between the third user and the second user, when a value for the data is transferred from the second user to the first user, at least a portion of the value for the data is also automatically transferred from the first user to the third user.

General and specific aspects disclosed above may be implemented using a system, a device, an integrated circuit, a computer program, or a computer-readable recording medium such as a CD-ROM, or any combination of systems, devices, integrated circuits, computer programs, or recording media.

Hereinafter, embodiments will be described with reference to the drawings. The embodiments described below show specific examples of the present disclosure. That is, the numerical values, shapes, materials, structural elements, the arrangement and connection of the structural elements, steps, the order of the steps, and the like shown in the embodiments given below are merely examples, and therefore are not intended to limit the scope of the present disclosure. Also, among the structural elements described in the following embodiments, structural elements not recited in any one of the independent claims are described as structural elements that are not necessarily required to address the problems of the present disclosure, but constitute preferred embodiments.

### Embodiment 1

First, a system configuration according to the present disclosure will be described.

Hereinafter, a configuration and the like of a management system according to the present embodiment will be described with reference to the drawings.

### Management System

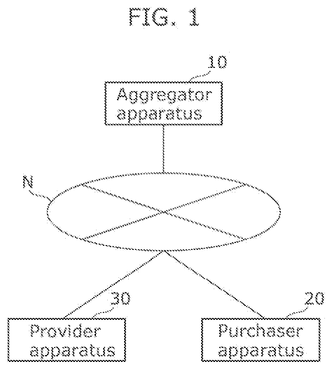

FIG. 1 is a diagram showing an example of a configuration of a management system according to Embodiment 1.

As shown in FIG. 1, the management system according to the present disclosure includes, for example, aggregator apparatus 10 owned by an aggregator who aggregates data to be traded (hereinafter referred to as “provision data”) that is acquired from a provider by using various types of devices, purchaser apparatus 20 owned by a purchaser who purchases the provision data aggregated by the aggregator, and provider apparatus 30 owned by the provider. These apparatuses are connected by network N. Network N is, for example, the Internet, a mobile phone carrier network, or the like, However, network N may be composed of any communication line or any network. In the management system, the aggregator receives provision data from a plurality of providers and aggregates the received provision data. When, for example, the aggregator receives a request from a purchaser, the aggregator sells the requested provision data to the purchaser. As described above, the management system is a system for the aggregator to mediate processing of buying and selling provision data.

The aggregator is an example of a first user. The purchaser is an example of a second user. The provider is an example of a third user. Aggregator apparatus 10 is an example of a first apparatus. Purchaser apparatus 20 is an example of a second apparatus. Provider apparatus 30 is an example of a third apparatus. A terminal is an example of an apparatus.

A description of aggregator apparatus 10 will be given below.

### Aggregator Apparatus 10

Aggregator apparatus 10 is an example of a device that collects data such as operation logs of one or more devices owned by the provider, and provides collected data or analysis data generated based on the collected data to the purchaser as provision data. The term “operation log” refers to, for example, information in which a detection result detected by a sensor included in the one or more devices, an operation state of the one or more devices, or the like are associated with time at which the detection result or the operation state was detected. The term “one or more devices” encompasses, for example, home electric appliances installed in a house, devices installed in a factory, a sensor that has a communication function, and the like. Aggregator apparatus 10 acquires the provision data via provider apparatus 30. Aggregator apparatus 10 may acquire the provision data directly from the one or more devices that generated the provision data, without passing through provider apparatus 30.

When data is purchased by the purchaser, aggregator apparatus 10 executes first payment processing for paying a value for the purchased data from the purchaser to the aggregator. Fee is an example of a value. Paying a value is an example of transferring a value. Aggregator apparatus 10 may transmit the data purchased by the purchaser to purchaser apparatus 20 of the purchaser at the time when executing the first payment processing. Also, when the first payment processing is executed, aggregator apparatus 10 may execute second payment processing for paying at least a portion of the value for the purchased data from the aggregator to the provider that provided the purchased data. The payment may be performed by delivering a token or electronic money corresponding to the amount of the value for the purchased data.

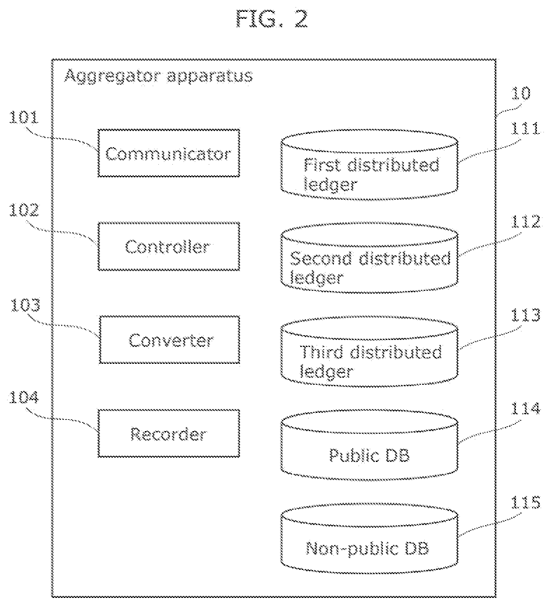

FIG. 2 is a diagram showing an example of a configuration of aggregator apparatus 10 according to Embodiment 1.

As shown in FIG. 2, aggregator apparatus 10 includes communicator 101, controller 102, converter 103, recorder 104, first distributed ledger 111, second distributed ledger 112, third distributed ledger 113, public database 114, and non-public database 115. Aggregator apparatus 10 may be implemented by a processor executing a predetermined program by using a memory. In FIG. 2, the public database is indicated as public DB, and the non-public database is indicated as non-public DB. A description of structural elements that are included in aggregator apparatus 10 will be given below.

### Communicator 101

Communicator 101 exchanges data with purchaser apparatus 20 or provider apparatus 30 by performing communication with purchaser apparatus 20 or provider apparatus 30.

Specifically, communicator 101 receives provision data that is provided from provider apparatus 30.

Also, communicator 101 receives, from provider apparatus 30, third ledger transaction data that includes third ledger information that indicates the distributed ledgers owned by provider apparatus 30. The distributed ledgers owned by provider apparatus 30 are distributed ledgers that are stored in provider apparatus 30, and specifically are first distributed ledger 111 and third distributed ledger 113.

Also, communicator 101 receives, from purchaser apparatus 20, second ledger transaction data that includes second ledger information that indicates the distributed ledgers owned by purchaser apparatus 20. The distributed ledgers owned by purchaser apparatus are distributed ledgers that are stored in purchaser apparatus 20, and specifically are second distributed ledger 112 and third distributed ledger 113.

Also, communicator 101 receives, from provider apparatus 30, first transaction data that includes a first payment smart contract. The first payment smart contract is a smart contract for transferring a value for data from an account held by the aggregator to an account held by the provider. The first payment smart contract includes an aggregator account address for identifying the account held by the aggregator, a provider account address for identifying the account held by the provider, an association smart contract ID for identifying a later-described association smart contract, a data ID for identifying provision data, and a first value that is the value for the provision data. The first payment smart contract is an example of a second smart contract.

Also, communicator 101 transmits second transaction data that includes a second payment smart contract to purchaser apparatus 20. The second payment smart contract is a smart contract for transferring a value for data from an account held by the purchaser to the account held by the aggregator. The second payment smart contract includes the aggregator account address for identifying the account held by the aggregator, a purchaser account address for identifying the account held by the purchaser, the association smart contract ID for identifying the later-described association smart contract, a data ID for identifying provision data, and a second value that is the value for the provision data, The second payment smart contract is an example of a first smart contract.

The first value for the provision data paid from the aggregator to the provider is at least a portion of the second value for the provision data paid from the purchaser to the aggregator.

Also, communicator 101 transmits third transaction data that includes an association smart contract to purchaser apparatus 20 and provider apparatus 30. The association smart contract is a smart contract for correlating the first payment smart contract and the second payment smart contract with each other. The second payment smart contract is generated for each data purchased by purchaser apparatus 20. Accordingly, the association smart contract is also generated for each data purchased by purchaser apparatus 20 so as to correspond to the second smart contract. The association smart contract is executed when the second payment smart contract is executed, and the association smart contract executes the first payment smart contract. The association smart contract includes a first address that indicates a storage location in a first payment blockchain in which the first payment smart contract is stored, a second address that indicates a storage location in a second payment blockchain in which the second payment smart contract is stored, and the association smart contract ID for identifying the association smart contract.

Also, communicator 101 receives, from purchaser apparatus 20, purchase transaction data that includes value information regarding the second value, which is the value for the provision data, to be paid by the purchaser to the aggregator. Fee information is an example of a value information, The purchase transaction data is transaction data for executing the second payment smart contract. The purchase transaction data includes a data ID for identifying the data to be purchased, a value for the data to be purchased, and a purchaser ID for identifying the purchaser.

Also, communicator 101 receives third execution transaction data from purchaser apparatus 20. The third execution transaction data is transaction data for executing the association smart contract.

Also, communicator 101 exchanges each transaction data with purchaser apparatus 20 or provider apparatus 30. Specifically, communicator 101 performs operations of transferring each transaction data from purchaser apparatus 20 or provider apparatus 30, receiving each transaction data transferred from purchaser apparatus 20 or provider apparatus 30, and the like. Each transaction data includes one of first ledger transaction data, the second ledger transaction data, the third ledger transaction data, the purchase transaction data, the first transaction data, the second transaction data, the third transaction data, the first execution transaction data, or the third execution transaction data.

As described above, communicator 101 performs communication with purchaser apparatus 20 or provider apparatus 30 via network N. The communication may be performed based on TLS (Transport Layer Security), and an encryption key for TLS communication may be held by communicator 101.

### Controller 102

Controller 102 generates first ledger transaction data that includes first ledger information that indicates the distributed ledgers owned by aggregator apparatus 10. The distributed ledgers owned by aggregator apparatus 10 are distributed ledgers that are stored in aggregator apparatus 10, and specifically are first distributed ledger 111, second distributed ledger 112, and third distributed ledger 113, Controller 102 transmits the generated first ledger transaction data to purchaser apparatus 20 and provider apparatus 30 via communicator 101 to store the first ledger transaction data in third distributed ledgers 113 of purchaser apparatus 20 and provider apparatus 30.

Also, controller 102 generates second transaction data that includes a second payment smart contract. Controller 102 transmits the generated second transaction data to purchaser apparatus 20 via communicator 101 to store the second transaction data in second distributed ledger 112 of purchaser apparatus 20. Specifically, when communicator 101 receives purchase transaction data from purchaser apparatus 20, controller 102 identifies, based on the data ID that indicates data to be purchased included in the purchase transaction data, the provider ID of the provider that provided the data to be purchased by referencing public data information managed by public database 114 and non-public data information managed by non-public database 115, which will be described later. Also, based on the data ID, controller 102 identifies the account address of provider apparatus based on the public data information and account information that are managed by public database 114, which will be described later, Controller 102 thereby identifies the first payment smart contract that is associated with the second payment smart contract.

Also, controller 102 generates third transaction data that includes association smart contract information. Controller 102 transmits the generated third transaction data to purchaser apparatus 20 and provider apparatus 30 via communicator 101 to store the third transaction data in third distributed ledgers 113 of purchaser apparatus 20 and provider apparatus 30.

Controller 102 may generate an association smart contract ID for identifying an association smart contract before the association smart contract is generated when the second payment smart contract is generated. Controller 102 may also generate an association smart contract by using the generated association smart contract ID after the second payment smart contract has been generated.

Also, when communicator 101 receives transaction data, controller 102 verifies the authenticity of the transaction data. For example, controller 102 verifies whether an electronic signature generated in a correct manner is attached to the transaction data received by communicator 101, or the like. This verification may be skipped. Here, the transaction data received by communicator 101 is any one of the second ledger transaction data, the third ledger transaction data, the first transaction data, the second transaction data, the purchase transaction data, the first execution transaction data, or the third execution transaction data.

Also, controller 102 executes a consensus algorithm for reaching an agreement on the authenticity of the transaction data together with at least one of purchaser apparatus 20 or provider apparatus 30.

As the consensus algorithm, PBFT (Practical Byzantine Fault Tolerance) may be used, or any other known consensus algorithm may be used. Examples of the known consensus algorithm include PoW (Proof of Work), PoS (Proof of Stake), and the like. In the case where PBFT is used as the consensus algorithm, controller 102 receives a report indicating whether the transaction data has been successfully verified from each apparatus that executes the consensus algorithm together with aggregator apparatus 10, and then determines whether the number of reports received is greater than a predetermined value. If it is determined that the number of reports received is greater than the predetermined value, controller 102 may determine that the authenticity of the transaction data has been verified by the consensus algorithm.

When the authenticity of the transaction data has been confirmed, controller 102 causes recorder 104 to record the transaction data. If it is not possible to confirm the authenticity of the transaction data, controller 102 does not cause recorder 104 to record the transaction data. With this configuration, memory consumption can be reduced.

In the present embodiment, controller 102 performs authenticity verification on the second ledger transaction data, the third ledger transaction data, the first transaction data, the second transaction data, the purchase transaction data, the first execution transaction data, and the third execution transaction data received by communicator 101.

### Converter 103

When communicator 101 receives provision data from provider apparatus 30, converter 103 references a conversion table, and converts a third identifier (provider ID) for identifying the provider included in the provision data to a third specific identifier. Converter 103 associates the provision data and the third specific identifier with each other, and stores them in public database 114. Converter 103 may convert the third identifier to the third specific identifier by using a predetermined hash function. That is, the third specific identifier may be a hash value of the third identifier. Different third identifiers are attached for each provider. Accordingly, data provided by different providers are associated with different third specific identifiers, and stored in public database 114.

### Recorder 104

Recorder 104 records transaction data by incorporating the transaction data that has undergone authenticity verification performed by controller 102 in a block and storing the block in any one of first distributed ledger 111, second distributed ledger 112, or third distributed ledger 113.

Recorder 104 may be internally provided with first distributed ledger 111, second distributed ledger 112, and third distributed ledger 113.

### First Distributed Ledger 111

First distributed ledger 111 stores information regarding contracts between the aggregator and the provider. First distributed ledger 111 stores, for example, first transaction data that includes a first payment smart contract. First distributed ledger 111 stores a first payment blockchain that includes a block that includes the first transaction data. The first payment blockchain is an example of a second blockchain.

### Second Distributed Ledger 112

Second distributed ledger 112 stores information regarding contracts between the aggregator and the purchaser. Second distributed ledger 112 stores, for example, second transaction data that includes a second payment smart contract. Second distributed ledger 112 stores a second payment blockchain that includes a block that includes the second transaction data. The second payment blockchain is an example of a first blockchain.

### Third Distributed Ledger 113

Third distributed ledger 113 stores information regarding the aggregator, the purchaser, and the provider. Third distributed ledger 113 stores, for example, third transaction data that includes an association smart contract. Third distributed ledger 113 stores a third blockchain that includes a block that includes the third transaction data.

### Public Database 114

The information stored in public database 114 is information that can be viewed by aggregator apparatus 10, purchaser apparatus 20, and provider apparatus 30.

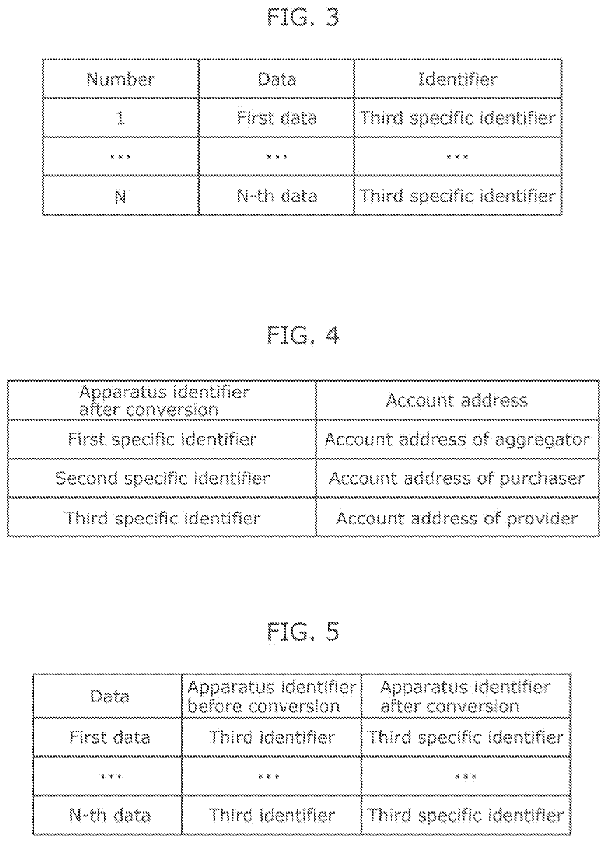

Public database 114 stores public data information regarding provision data acquired from provider apparatus 30. FIG. 3 shows a table that shows an example of a configuration of the public data information.

As shown in FIG. 3, the public data information is information in which, for each of a plurality of data items, a data number for identifying the data item, the data item, and a third specific identifier that is an identifier of the provider that provided the data item obtained after conversion are associated with each other.

Also, public database 114 stores account information in which specific identifiers of aggregator apparatus 10, purchaser apparatus and provider apparatus 30 and account addresses of aggregator apparatus 10, purchaser apparatus 20, and provider apparatus 30 are associated with each other. FIG. 4 shows a table that shows an example of a configuration of the account information.

As shown in FIG. 4, the account information is information in which each specific identifier that is an identifier of an apparatus obtained after conversion is associated with the account address of the apparatus identified by the specific identifier. For example, a first specific identifier is associated with the account address of aggregator apparatus 10, a second specific identifier is associated with the account address of purchaser apparatus 20, and a third specific identifier is associated with the account address of provider apparatus 30.

The first specific identifier is an identifier obtained by converting a first identifier (aggregator ID) for identifying the aggregator. For example, the first specific identifier is an identifier obtained by converting the first identifier by using a predetermined hash function. Also, the second specific identifier is an identifier obtained by converting a second identifier (purchaser ID) for identifying the purchaser. For example, the second specific identifier is an identifier obtained by converting the second identifier by using a predetermined hash function.

### Non-Public Database 115

The information stored in non-public database 115 is information that cannot be viewed by aggregator apparatus 10, purchaser apparatus 20, and provider apparatus 30. The information stored in non-public database 115 may be information that can be viewed by aggregator apparatus 10, but cannot be viewed by purchaser apparatus 20 and provider apparatus 30.

Non-public database 115 stores non-public data information regarding provision data acquired from provider apparatus 30. FIG. 5 shows a table that shows an example of a configuration of the non-public data information.

As shown in FIG. 5, the non-public data information is information in which, for each of a plurality of data items, the data item and a third specific identifier that is an identifier of the provider that provided the data item obtained after conversion are associated with each other. The non-public data information may also be associated with a data number for identifying each data item.

Next, a description of purchaser apparatus 20 will be given.

### Purchaser Apparatus 20

Purchaser apparatus 20 is an apparatus for purchasing a desired data item from among data items aggregated by aggregator apparatus 10. Purchaser apparatus 20 receives a desired data item by transmitting a request for purchasing the desired data item to aggregator apparatus 10 and paying a value for the desired data item to aggregator apparatus 10.

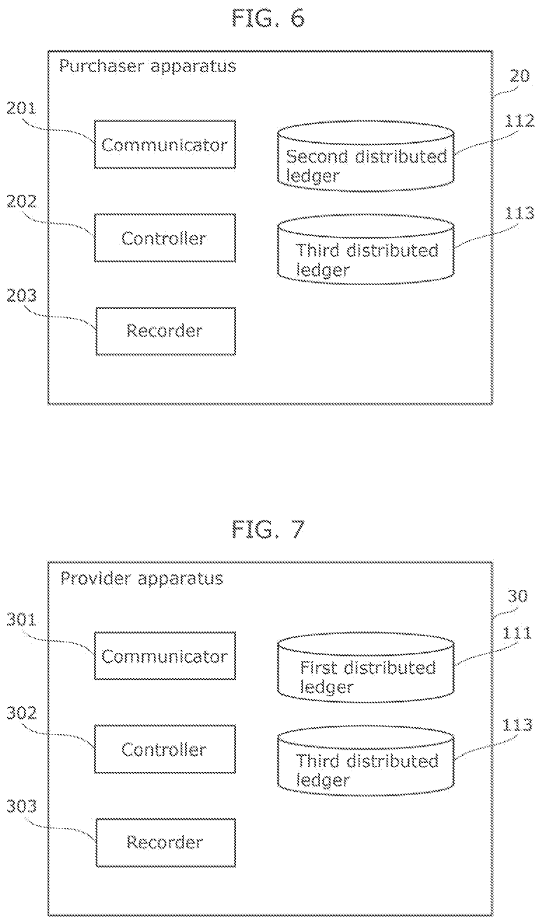

FIG. 6 is a diagram showing an example of a configuration of purchaser apparatus 20 according to Embodiment 1.

As shown in FIG. 6, purchaser apparatus 20 includes communicator 201, controller 202, recorder 203, second distributed ledger 112, and third distributed ledger 113. Purchaser apparatus may be implemented by a processor executing a predetermined program by using a memory. A description of structural elements that are included in purchaser apparatus 20 will be given below.

### Communicator 201

Communicator 201 exchanges data with aggregator apparatus 10 by performing communication with aggregator apparatus 10.

Specifically, communicator 201 transmits second ledger transaction data that includes second ledger information that indicates the distributed ledgers owned by purchaser apparatus 20 to aggregator apparatus 10. The distributed ledgers owned by purchaser apparatus 20 are distributed ledgers that are stored in purchaser apparatus 20, and specifically are second distributed ledger 112 and third distributed ledger 113.

Also, communicator 201 receives, from aggregator apparatus third transaction data that includes an association smart contract. Also, communicator 201 transmits, to aggregator apparatus 10, purchase transaction data that includes value information regarding a second value that is a value for provision data to be paid by the purchaser to the aggregator. Also, communicator 20 transmits second execution transaction data to aggregator apparatus 10 and provider apparatus 30.

Also, communicator 201 exchanges each transaction data with at least one of aggregator apparatus 10 or provider apparatus 30. Specifically, communicator 201 transfers and receives each transaction data to and from aggregator apparatus 10 or provider apparatus 30. Each transaction data includes at least one of the first ledger transaction data, the second ledger transaction data, the third ledger transaction data, the second transaction data, the third transaction data, the first execution transaction data, or the second execution transaction data.

As described above, communicator 201 performs communication with aggregator apparatus 10 or provider apparatus 30 via network N. The communication may be performed based on TLS (Transport Layer Security), and an encryption key for TLS communication may be held by communicator 201.

### Controller 202

Controller 202 generates second ledger transaction data that includes second ledger information that indicates the distributed ledgers owned by purchaser apparatus 20. Also, controller 202 generates second execution transaction data.

Also, when communicator 201 receives transaction data, controller 202 verifies the authenticity of the transaction data. For example, controller 202 verifies whether an electronic signature generated in a correct manner is attached to the transaction data received by communicator 201, or the like. This verification may be skipped. Here, the transaction data received by communicator 201 is any one of the first ledger transaction data, the third ledger transaction data, the second transaction data, the third transaction data, the first execution transaction data, or the second execution transaction data.

Also, controller 202 executes a consensus algorithm for reaching an agreement on the authenticity of the transaction data together with at least one of aggregator apparatus 10 or provider apparatus 30.

As the consensus algorithm, PBFT (Practical Byzantine Fault Tolerance) may be used, or any other known consensus algorithm may be used. Examples of the known consensus algorithm include PoW (Proof of Work), PoS (Proof of Stake), and the like. In the case where PBFT is used as the consensus algorithm, controller 202 receives a report indicating whether the transaction data has been successfully verified from each apparatus that executes the consensus algorithm together with purchaser apparatus 20, and then determines whether the number of reports received is greater than a predetermined value. If it is determined that the number of reports received is greater than the predetermined value, controller 202 may determine that the authenticity of the transaction data has been verified by the consensus algorithm.

When the authenticity of the transaction data has been confirmed, controller 202 causes recorder 203 to record the transaction data. If it is not possible to confirm the authenticity of the transaction data, controller 202 does not cause recorder 203 to record the transaction data. With this configuration, memory consumption can be reduced.

In the present embodiment, controller 202 performs authenticity verification on any one of the second ledger transaction data, the third ledger transaction data, the first transaction data, the second transaction data, the purchase transaction data, the first execution transaction data, or the second execution transaction data received by communicator 201.

### Recorder 203

Recorder 203 records transaction data by incorporating the transaction data that has undergone authenticity verification performed by controller 202 in a block and storing the block in any one of second distributed ledger 112 or third distributed ledger 113.

Recorder 203 may be internally provided with second distributed ledger 112 and third distributed ledger 113.

Second distributed ledger 112 and third distributed ledger 113 have the same configurations as those of second distributed ledger 112 and third distributed ledger 113 of aggregator apparatus 10. Accordingly, a description thereof is omitted here.

### Provider Apparatus 30

Provider apparatus 30 is an apparatus for providing data to aggregator apparatus 10. Provider apparatus 30 is an apparatus for receiving at least a portion of a value for data purchased by purchaser apparatus 20 from aggregator apparatus 10.

FIG. 7 is a diagram showing an example of a configuration of provider apparatus 30 according to Embodiment 1.

As shown in FIG. 7, provider apparatus 30 includes communicator 301, controller 302, recorder 303, first distributed ledger 111, and third distributed ledger 113. Provider apparatus 30 may be implemented by a processor executing a predetermined program by using a memory. A description of structural elements that are included in provider apparatus 30 will be given below.

### Communicator 301

Communicator 301 exchanges data with aggregator apparatus 10 by performing communication with aggregator apparatus 10.

Specifically, communicator 301 transmits provision data to aggregator apparatus 10.

Also, communicator 301 transmits third ledger transaction data that includes third ledger information that indicates the distributed ledgers owned by provider apparatus 30 to aggregator apparatus 10. The distributed ledgers owned by provider apparatus 30 are distributed ledgers that are stored in provider apparatus 30, and specifically are first distributed ledger 111 and third distributed ledger 113.

Also, communicator 301 transmits first transaction data that includes a first payment smart contract to aggregator apparatus 10. Also, communicator 301 receives third transaction data that includes an association smart contract from aggregator apparatus 10.

Also, communicator 301 exchanges each transaction data with at least one of aggregator apparatus 10 or purchaser apparatus 20. Specifically, communicator 301 performs operations of transferring each transaction data to aggregator apparatus 10 or purchaser apparatus 20, receiving each transaction data transferred from aggregator apparatus 10 or purchaser apparatus 20, and the like. Each transaction data includes at least one of the first ledger transaction data, the second ledger transaction data, the third ledger transaction data, the first transaction data, the third transaction data, the first execution transaction data, or the second execution transaction data.

As described above, communicator 301 performs communication with aggregator apparatus 10 or purchaser apparatus 20 via network N. The communication may be performed based on TLS (Transport Layer Security), and an encryption key for TLS communication may be held by communicator 301.

### Controller 302

Controller 302 generates third ledger transaction data that includes third ledger information that indicates the distributed ledgers owned by provider apparatus 30. Also, controller 302 generates first execution transaction data.

Also, controller 302 generates first transaction data that includes a first payment smart contract. Controller 302 transmits the generated first transaction data to aggregator apparatus 10 via communicator 301 to store the first transaction data in first distributed ledger 111.

Controller 302 may generate an association smart contract ID, and generate a first payment smart contract that includes the generated association smart contract ID before an association smart contract is generated when the first payment smart contract is generated. Then, controller 302 may transmit the generated association smart contract ID to aggregator apparatus 10. When aggregator apparatus 10 receives the association smart contract ID from provider apparatus 30, aggregator apparatus 10 may generate a second payment smart contract and an association smart contract by using the received association smart contract ID. Conversely, controller 302 may transmit an inquiry as to whether an association smart contract ID has already been generated by aggregator apparatus 10 when generating a first payment smart contract. If it is determined, as a result of the inquiry, that an association smart contract ID has already been generated by aggregator apparatus 10, controller 302 may acquire the association smart contract ID from aggregator apparatus 10, and generate a first payment smart contract that includes the acquired association smart contract ID. In this case, controller 302 does not necessarily need to generate an association smart contract ID.

Also, when communicator 301 receives transaction data, controller 302 verifies the authenticity of the transaction data. For example, controller 302 verifies whether an electronic signature generated in a correct manner is attached to the transaction data received by communicator 301, or the like. This verification may be skipped. Here, the transaction data received by communicator 301 is any one of the first ledger transaction data, the second ledger transaction data, the third transaction data, the first execution transaction data, or the second execution transaction data.

Also, controller 302 executes a consensus algorithm for reaching an agreement on the authenticity of the transaction data together with at least one of aggregator apparatus 10 or purchaser apparatus 20.

As the consensus algorithm, PBFT (Practical Byzantine Fault Tolerance) may be used, or any other known consensus algorithm may be used. Examples of the known consensus algorithm include POW (Proof of Work), PoS (Proof of Stake), and the like. In the case where PBFT is used as the consensus algorithm, controller 302 receives a report indicating whether the transaction data has been successfully verified from each apparatus that executes the consensus algorithm together with provider apparatus 30, and then determines whether the number of reports received is greater than a predetermined value. If it is determined that the number of reports received is greater than the predetermined value, controller 302 may determine that the authenticity of the transaction data has been verified by the consensus algorithm.

When the authenticity of the transaction data has been confirmed, controller 302 causes recorder 303 to record the transaction data. If it is not possible to confirm the authenticity of the transaction data, controller 302 does not cause recorder 303 to record the transaction data. With this configuration, memory consumption can be reduced.

In the present embodiment, controller 302 performs authenticity verification on any one of the first ledger transaction data, the second ledger transaction data, the third transaction data, the first execution transaction data, or the second execution transaction data received by communicator 301.

### Recorder 303

Recorder 303 records transaction data by incorporating the transaction data that has undergone authenticity verification performed by controller 302 in a block and storing the block in any one of first distributed ledger 111 or third distributed ledger 113.

Recorder 303 may be internally provided with first distributed ledger 111 and third distributed ledger 113.

First distributed ledger 111 and third distributed ledger 113 have the same configurations as those of first distributed ledger 111 and third distributed ledger 113 of aggregator apparatus 10. Accordingly, a description thereof is omitted here.

### Operations of Management System, etc.

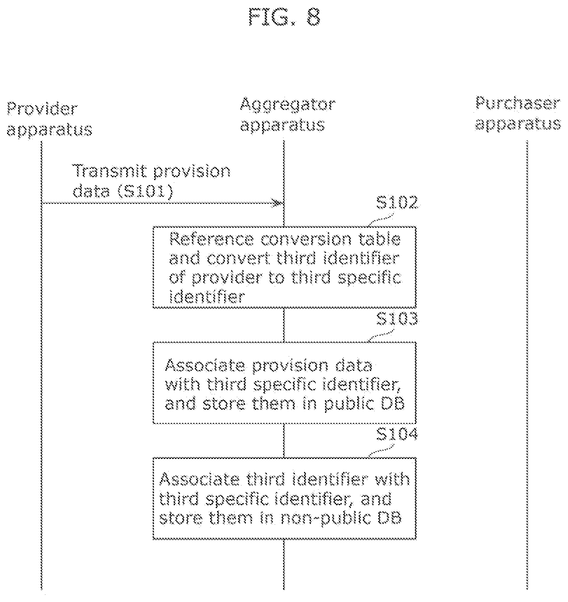

Next, a description of operations performed by the management system configured as described above will be given. In FIG. 8 and the subsequent diagrams, transaction data is expressed as Tx data.

FIG. 8 is a sequence diagram illustrating an example of data acquiring processing performed by the management system according to Embodiment 1.

The data acquiring processing is processing performed by aggregator apparatus 10 when aggregator apparatus 10 acquires provision data from provider apparatus 30.

Provider apparatus 30 transmits provision data to aggregator apparatus 10 (S101). Provider apparatus 30 may transmit provision data to aggregator apparatus 10 on a regular basis. The provision data includes a third identifier for identifying provider apparatus 30.

When aggregator apparatus 10 receives provision data from provider apparatus 30, aggregator apparatus 10 references a conversion table, and converts the third identifier included in the provision data to a third specific identifier (S102).

Next, aggregator apparatus 10 associates the received provision data with the third specific identifier obtained through the conversion, and stores the provision data and the third specific identifier in public database 114 (S103).

Next, aggregator apparatus 10 associates the third identifier with the third specific identifier, and stores the third identifier and the third specific identifier in non-public database 115 (S104).

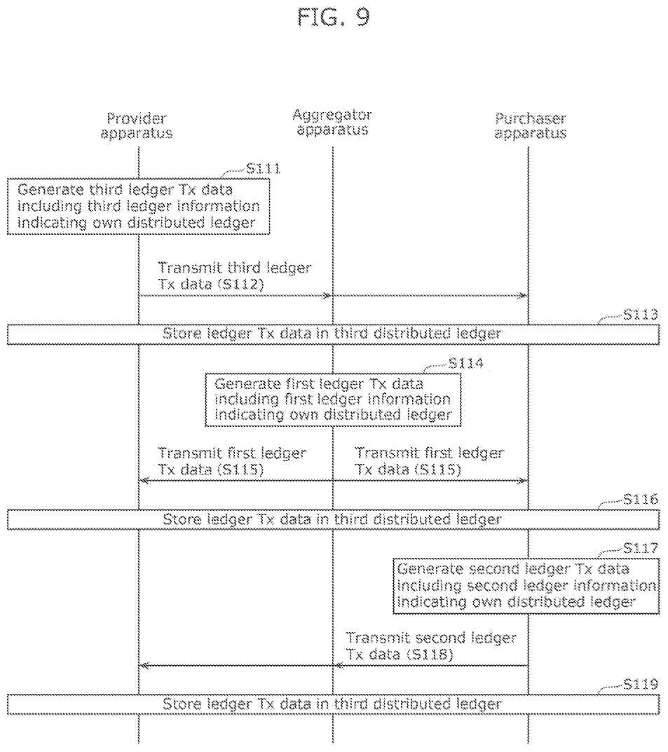

FIG. 9 is a sequence diagram illustrating an example of processing of storing distributed ledger information in distributed ledgers performed by the management system according to Embodiment 1.

Provider apparatus 30 generates third ledger transaction data that includes third ledger information that indicates the distributed ledgers owned by provider apparatus 30 (S111).

Provider apparatus 30 transmits the generated third ledger transaction data to aggregator apparatus 10 and purchaser apparatus (S112).

Next, each of aggregator apparatus 10, purchaser apparatus and provider apparatus 30 executes a consensus algorithm to generate a block that includes the third ledger transaction data, and stores the generated block in third distributed ledger 113 (S113).

Aggregator apparatus 10 generates first ledger transaction data that includes first ledger information that indicates the distributed ledgers owned by aggregator apparatus 10 (S114).

Aggregator apparatus 10 transmits the generated first ledger transaction data to purchaser apparatus 20 and provider apparatus (S115).

Next, each of aggregator apparatus 10, purchaser apparatus and provider apparatus 30 executes a consensus algorithm to generate a block that includes the first ledger transaction data, and stores the generated block in third distributed ledger 113 (S116).

Purchaser apparatus 20 generates second ledger transaction data that includes second ledger information that indicates the distributed ledgers owned by purchaser apparatus 20 (S117).

Purchaser apparatus 20 transmits the generated second ledger transaction data to aggregator apparatus 10 and provider apparatus (S118).

Next, each of aggregator apparatus 10, purchaser apparatus and provider apparatus 30 executes a consensus algorithm to generate a block that includes the second ledger transaction data, and stores the generated block in third distributed ledger 113 (S119).

The processing of storing distributed ledger information in distributed ledgers may be performed when the distributed ledgers owned by any one of the apparatuses are set or updated. The series of processing operations of steps S111 to S113, the series of processing operations of steps S114 to S116, and the series of processing operations of step S117 to S119 do not necessarily need to be performed in this order. Also, the series of processing operations of steps S111 to S113, the series of processing operations of steps S114 to S116, and the series of processing operations of steps S117 to S119 may be performed only once, or each time the configurations of the distributed ledgers owned by any one of the apparatuses are updated.

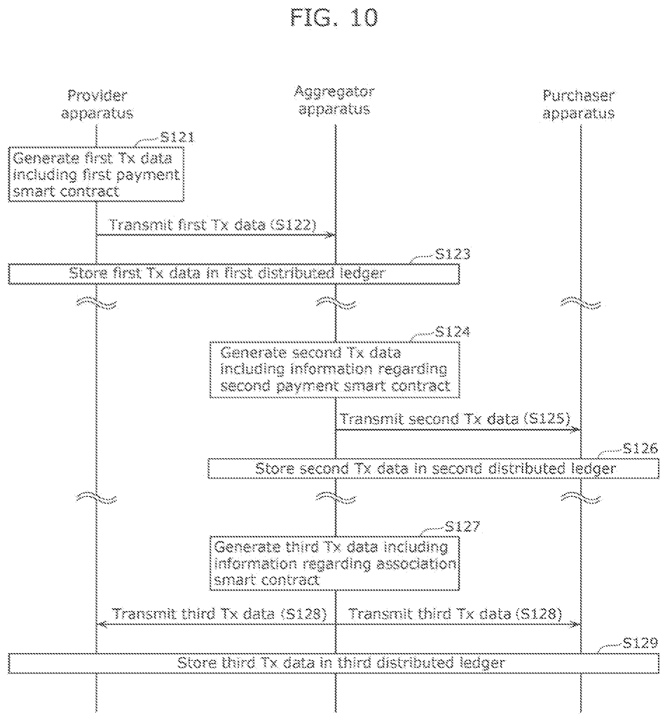

FIG. 10 is a sequence diagram illustrating an example of processing of storing smart contracts in distributed ledgers performed by the management system according to Embodiment 1.

Provider apparatus 30 generates first transaction data that includes a first payment smart contract (S121).

Provider apparatus 30 transmits the generated first transaction data to aggregator apparatus 10 and purchaser apparatus 20 (S122).

Next, each of aggregator apparatus 10 and provider apparatus executes a consensus algorithm to generate a block that includes the first transaction data, and stores the generated block in first distributed ledger 111 (S123).

Aggregator apparatus 10 generates second transaction data that includes a second payment smart contract (S124).

Aggregator apparatus 10 transmits the generated second transaction data to purchaser apparatus 20 (S125).

Next, each of aggregator apparatus 10 and purchaser apparatus 20 executes a consensus algorithm to generate a block that includes the second transaction data, and stores the generated block in second distributed ledger 112 (S126).

Aggregator apparatus 10 generates third transaction data that includes an association smart contract (S127),

Aggregator apparatus 10 transmits the generated third transaction data to purchaser apparatus 20 and provider apparatus (S128).

Next, each of aggregator apparatus 10, purchaser apparatus and provider apparatus 30 executes a consensus algorithm to generate a block that includes the third transaction data, and stores the generated block in third distributed ledger 113 (S129).

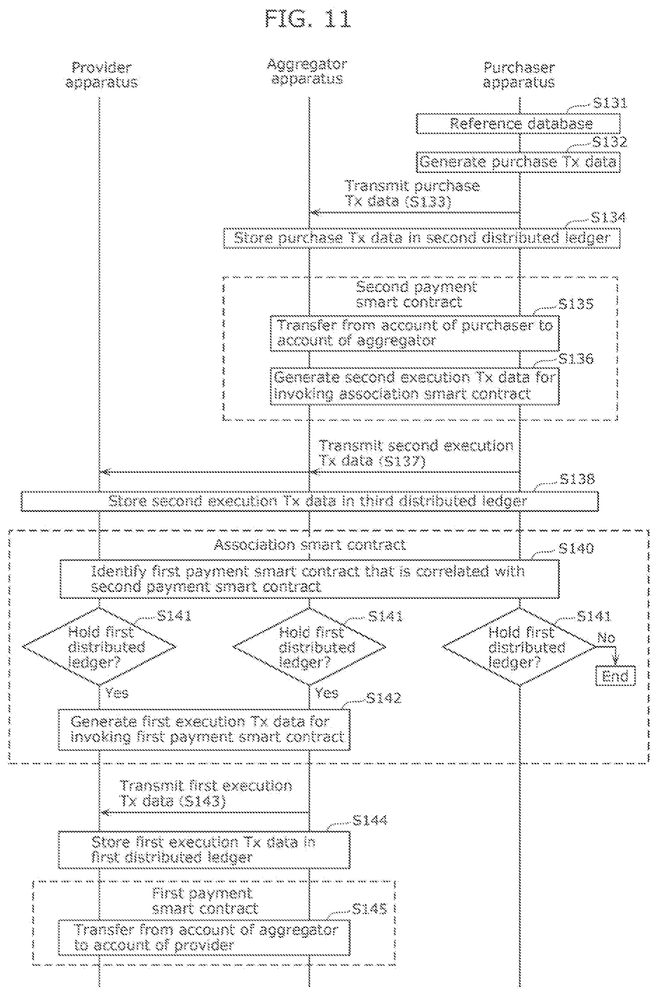

FIG. 11 is a sequence diagram illustrating an example of data buy-sell processing performed by the management system according to Embodiment 1.

Purchaser apparatus 20 references a database that includes a list of data to be traded, and designates data to be purchased (S131).

Purchaser apparatus 20 generates purchase transaction data that includes information that indicates the data to be purchased and a value for the data (S132).

Purchaser apparatus 20 transmits the generated purchase transaction data to aggregator apparatus 10 (S133).

Next, each of aggregator apparatus 10 and purchaser apparatus 20 executes a consensus algorithm to generate a block that includes the purchase transaction data, and stores the generated block in second distributed ledger 112 of each of aggregator apparatus 10 and purchaser apparatus 20 (S134).

Next, when the consensus algorithm has been executed on the purchase transaction data, each of aggregator apparatus 10 and purchaser apparatus 20 executes a second payment smart contract (S135 and S136).

Each of aggregator apparatus 10 and purchaser apparatus 20 transfers the value for the data from the account held by the purchaser to the account held by the aggregator (S135).

Next, each of aggregator apparatus 10 and purchaser apparatus 20 generates second execution transaction data for invoking an association smart contract (S136). The second execution transaction data includes an association smart contract ID.

Next, at least one of aggregator apparatus 10 or purchaser apparatus 20 transmits the second execution transaction data to the remaining ones of the three apparatuses that each own third distributed ledger 113 that stores the association smart contract including aggregator apparatus 10, purchaser apparatus 20, and provider apparatus 30 other than the own apparatus (S137). FIG. 11 shows an example in which purchaser apparatus 20 transmits the second execution transaction data to aggregator apparatus 10 and provider apparatus 30. Aggregator apparatus 10 may transmit the second execution transaction data to purchaser apparatus 20 and provider apparatus 30. With this configuration, the amount of processing by the processor of the management system can be reduced, and the power consumption of the management system can also be reduced as compared with when both of aggregator apparatus 10 and purchaser apparatus 20 execute the processing of S137.

Next, each of aggregator apparatus 10, purchaser apparatus 20, and provider apparatus 30 executes a consensus algorithm to generate a block that includes the second execution transaction data, and stores the generated block in third distributed ledger 113 (S138).

Next, when the consensus algorithm has been executed on the second execution transaction data, each of aggregator apparatus 10, purchaser apparatus 20, and provider apparatus 30 executes an association smart contract (S140 to S142).

Next, each of aggregator apparatus 10, purchaser apparatus and provider apparatus 30 identifies a first payment smart contract that is correlated with the second payment smart contract (S140). Specifically, each of aggregator apparatus 10, purchaser apparatus 20, and provider apparatus 30 identifies the first payment smart contract based on a first address that indicates a storage location in a first payment blockchain in which the first payment smart contract is stored, the first address being included in the association smart contract.

Next, each of aggregator apparatus 10, purchaser apparatus 20, and provider apparatus 30 determines whether the apparatus holds first distributed ledger 111 (S141). Specifically, each of aggregator apparatus 10, purchaser apparatus 20, and provider apparatus 30 determines whether the apparatus holds first distributed ledger 111 based on the distributed ledger information stored in third distributed ledger 113 of the apparatus. Because each of aggregator apparatus 10 and provider apparatus 30 holds first distributed ledger 111, Yes is determined, and each of aggregator apparatus 10 and provider apparatus 30 performs the next step (step S142). Purchaser apparatus 20, on the other hand, does not hold first distributed ledger 111, and thus No is determined, and purchaser apparatus 20 ends the processing.

Next, each of aggregator apparatus 10 and provider apparatus generates first execution transaction data for invoking a first payment smart contract (S142). The first execution transaction data includes a first payment smart contract ID for identifying the first payment smart contract. Purchaser apparatus 20 does not execute the processing of S142 because purchaser apparatus 20 does not own first distributed ledger 111. With this configuration, the amount of processing by the processor of the management system and the power consumption of the management system can be reduced.

Next, at least one of aggregator apparatus 10 or provider apparatus 30 transmits the first execution transaction data to the other one of aggregator apparatus 10 or provider apparatus 30 that owns first distributed ledger 111 that stores the first payment smart contract (S143). FIG. 11 shows an example in which aggregator apparatus 10 transmits the first execution transaction data to provider apparatus 30. Provider apparatus 30 may transmit the first execution transaction data to aggregator apparatus 10. As described above, either one of aggregator apparatus 10 or provider apparatus 30 transmits the first execution transaction data to the other one of aggregator apparatus 10 or provider apparatus 30, and thus the amount of processing by the processor of the management system can be reduced, and the power consumption of the management system can also be reduced as compared with when both of aggregator apparatus 10 and provider apparatus 30 execute the processing of S143. Also, in S143, the first execution transaction data is not transmitted to purchaser apparatus 20 that does not own first distributed ledger 111. With this configuration, the processing of transmitting the first execution transaction data can be omitted, and thus the amount of processing by the processor of the management system can be reduced, and the power consumption of the management system can also be reduced.

Next, each of aggregator apparatus 10 and provider apparatus executes a consensus algorithm to generate a block that includes the first execution transaction data, and stores the generated block in first distributed ledger 111 (S144).

Next, when the consensus algorithm has been executed on the first execution transaction data, each of aggregator apparatus 10 and provider apparatus 30 executes a first payment smart contract (S145). Specifically, each of aggregator apparatus 10 and provider apparatus transfers at least a portion of the value for data from the account held by the aggregator to the account held by the provider (S145). As described above, aggregator apparatus 10 and provider apparatus that each own first distributed ledger 111 execute the processing of S142, S143, S144, and S145. On the other hand, purchaser apparatus 20 that does not own first distributed ledger 111 does not execute the processing of S142, S143, S144, and S145, and thus the amount of processing by the processor of the management system can be reduced. With this configuration, the power consumption of the management system can be reduced.

### Advantageous Effects, etc.

As described above, aggregator apparatus 10 included in the management system according to Embodiment 1 performs the following method. Aggregator apparatus 10 acquires, from purchaser apparatus 20 owned by a purchaser, purchase transaction data that includes value information regarding a value to be paid from the purchaser to the aggregator (S133). Aggregator apparatus 10 records the purchase transaction data in a second payment blockchain, and thereby executes a second payment smart contract recorded in the second payment blockchain (S135 and S136). Aggregator apparatus 10 executes a first payment smart contract recorded in a first payment blockchain that is different from the second payment blockchain based on the second payment smart contract (S145). The first payment smart contract is a smart contract for transferring at least a portion of the value for provision data from the account held by the aggregator to the account held by the provider.

With this configuration, two smart contracts for executing two types of provision data value transfer contracts, the two smart contracts corresponding to the two types of provision data value transfer contracts, are recorded separately in two different blockchains. One of the two types of provision data value transfer contracts is a payment contract for paying a value for provision data from the purchaser to the aggregator that is generated when the purchaser purchases the provision data. The other one of the two types of provision data value transfer contracts is a payment contract for paying at least a portion of the value for provision data from the aggregator to the provider that is generated when the purchaser purchases the provision data. As described above, the two types of data value transfer contracts are a contract between the aggregator and the purchaser and a contract between the aggregator and the provider, and thus combinations of users who are the parties involved in the contracts are different. That is, by separately recording two smart contracts in two different blockchains, it is possible to prevent a user other than the parties involved in a contract from knowing a smart contract that corresponds to the contract. Specifically, it is possible to prevent a contract of a user of one of the purchaser or the provider from being known to a user of the other one of the purchaser or the provider. As described above, even when two smart contracts are separately recorded in two different blockchains, aggregator apparatus 10 jointly executes the two smart contracts, and it is therefore possible to jointly execute the two types of provision data value transfer contracts while preventing the two types of provision data value transfer contracts from being known to the other. Accordingly, for example, in the case where the provider is a provider that provides provision data, and the aggregator is a mediator for buying and selling the provision data between the provider and the purchaser, when a value for the provision data is paid from the purchaser to the aggregator, at least a portion of the value for the provision data is also automatically paid from the aggregator to the provider.

Also, aggregator apparatus 10 generates second execution transaction data for executing an association smart contract recorded in a third blockchain that is different from the first payment blockchain and the second payment blockchain during execution of the second payment smart contract (S136). Next, aggregator apparatus 10 records the second execution transaction data in the third blockchain (S138), and thereby executes the association smart contract (S140 to S142).

Accordingly, by executing the second payment smart contract, aggregator apparatus 10 can execute the association smart contract.

Also, during execution of the association smart contract, aggregator apparatus 10 identifies a first payment smart contract that is a smart contract that is correlated with the second payment smart contract (S140), and generates first execution transaction data for executing the first payment smart contract (S142). Aggregator apparatus 10 records the first execution transaction data in the first payment blockchain (S144), and thereby executes the first payment smart contract (S145).

Accordingly, by executing the second payment smart contract, aggregator apparatus 10 can execute the association smart contract. Furthermore, by executing the association smart contract, aggregator apparatus 10 can execute the first payment smart contract.

Also, aggregator apparatus 10 transfers the value for the provision data from the account held by the purchaser to the account held by the aggregator during execution of the second payment smart contract.

With this configuration, by aggregator apparatus 10 executing the second payment smart contract, the purchaser can pay the value for the provision data to the aggregator.

Also, aggregator apparatus 10 determines whether aggregator apparatus 10 holds a first payment blockchain (S141) during execution of the second payment smart contract. If it is determined that aggregator apparatus 10 holds a first payment blockchain, aggregator apparatus 10 executes the first payment smart contract (S145).

With this configuration, aggregator apparatus 10 that holds the first payment blockchain can execute the first payment smart contract.

Also, the value is a value for provision data that is provided from the provider. The provision data is stored publicly in association with a third specific identifier that is an identifier obtained by converting a third identifier (provider ID) for identifying the provider. The third identifier is stored privately in association with the third specific identifier. Accordingly, the identifier of the third user can be managed, with the identifier of the third user being stored privately and in association with the data.

### Embodiment 2

Embodiment 2 is different from Embodiment 1 in that data buy-sell processing performed by a management system according to Embodiment 2 is partially changed. The configuration of the management system of the present embodiment is the same as that of the management system of Embodiment 1. Accordingly, a description thereof is omitted here.

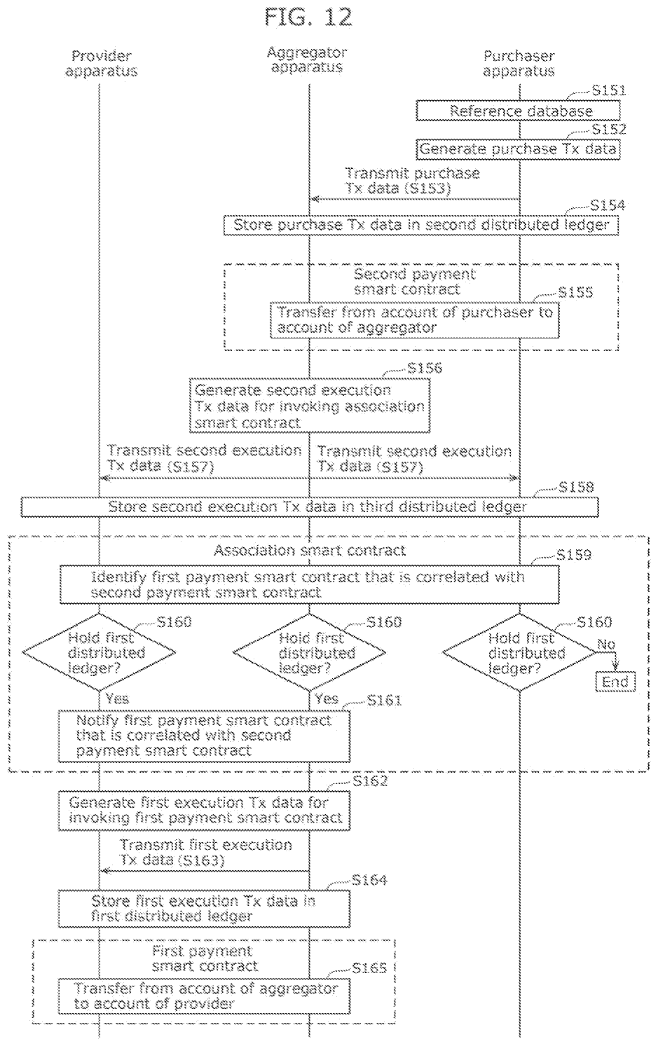

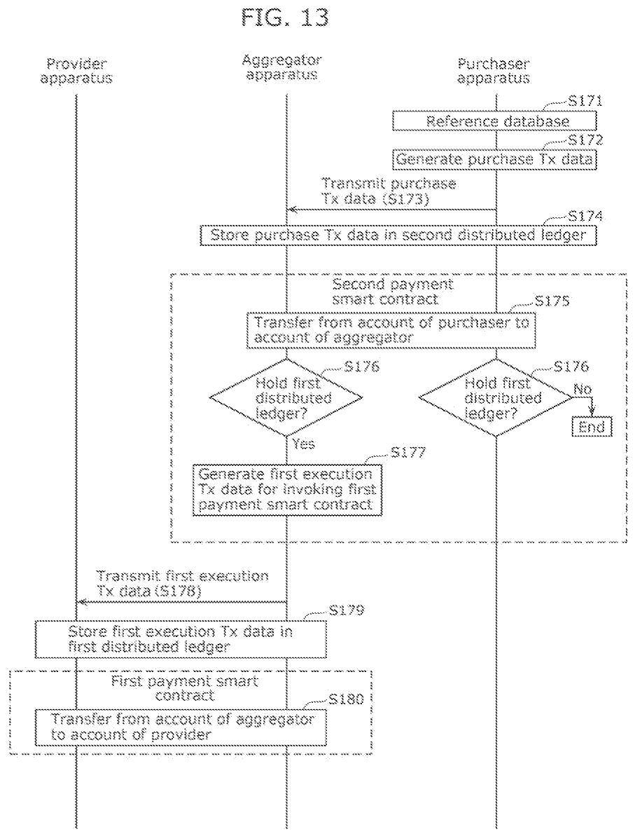

FIG. 12 is a sequence diagram illustrating an example of data buy-sell processing performed by the management system according to Embodiment 2.

Purchaser apparatus 20 references a database that includes a list of data to be traded, and designates data to be purchased (S151).

Purchaser apparatus 20 generates purchase transaction data that includes information that indicates the data to be purchased and a value for the data (S152).

Purchaser apparatus 20 transmits the generated purchase transaction data to aggregator apparatus 10 (S153).

Next, each of aggregator apparatus 10 and purchaser apparatus 20 executes a consensus algorithm to generate a block that includes the purchase transaction data, and stores the generated block in second distributed ledger 112 that stores the second payment smart contract (S154).

Next, when the consensus algorithm has been executed on the purchase transaction data, each of aggregator apparatus 10 and purchaser apparatus 20 executes a second payment smart contract (S155). Specifically, each of aggregator apparatus 10 and purchaser apparatus 20 transfers the value for the data from the account held by the purchaser to the account held by the aggregator (S155),

Next, aggregator apparatus 10 generates second execution transaction data for invoking an association smart contract (S156). The second execution transaction data includes an association smart contract ID.

Next, aggregator apparatus 10 transmits the second execution transaction data to purchaser apparatus 20 and provider apparatus 30 that each own third distributed ledger 113 that stores the association smart contract (S157).

Next, each of aggregator apparatus 10, purchaser apparatus 20, and provider apparatus 30 executes a consensus algorithm to generate a block that includes the second execution transaction data, and stores the generated block in third distributed ledger 113 (S158).

Next, when the consensus algorithm has been executed on the second execution transaction data, each of aggregator apparatus 10, purchaser apparatus 20, and provider apparatus 30 executes an association smart contract (S159 to S161).

Next, each of aggregator apparatus 10, purchaser apparatus and provider apparatus 30 identifies a first payment smart contract that is correlated with the second payment smart contract (S159). Specifically, each of aggregator apparatus 10, purchaser apparatus 20, and provider apparatus 30 identifies the first payment smart contract based on a first address that indicates a storage location in a first payment blockchain in which the first payment smart contract is stored, the first address being included in the association smart contract.

Next, each of aggregator apparatus 10, purchaser apparatus 20, and provider apparatus 30 determines whether the apparatus holds first distributed ledger 111 (S160). Specifically, each of aggregator apparatus 10, purchaser apparatus 20, and provider apparatus 30 determines whether the apparatus holds first distributed ledger 111 based on the distributed ledger information stored in third distributed ledger 113 of the apparatus. Because each of aggregator apparatus 10 and provider apparatus 30 holds first distributed ledger 111, Yes is determined, and each of aggregator apparatus 10 and provider apparatus 30 performs the next step (S161). Purchaser apparatus 20, on the other hand, does not hold first distributed ledger 111, and thus No is determined, and purchaser apparatus 20 ends the processing.

Next, each of aggregator apparatus 10 and provider apparatus transmits a notification of the first payment smart contract that is correlated with the second payment smart contract (S161). Purchaser apparatus 20 does not execute the processing of S161 because purchaser apparatus 20 does not own first distributed ledger 111. With this configuration, the amount of processing by the processor of the management system and the power consumption of the management system can be reduced.

Next, each of aggregator apparatus 10 and provider apparatus 30 generates first execution transaction data for invoking the first payment smart contract (S162). The first execution transaction data includes a first payment smart contract ID for identifying the first payment smart contract.

Next, at least one of aggregator apparatus 10 or provider apparatus 30 transmits the first execution transaction data to the other one of aggregator apparatus 10 or provider apparatus 30 that owns first distributed ledger 111 that stores the first payment smart contract (S163). FIG. 12 shows an example in which aggregator apparatus 10 transmits the first execution transaction data to provider apparatus 30. Provider apparatus 30 may transmit the first execution transaction data to aggregator apparatus 10. As described above, either one of aggregator apparatus 10 or provider apparatus 30 transmits the first execution transaction data to the other one of aggregator apparatus 10 or provider apparatus 30, and thus the amount of processing by the processor of the management system can be reduced, and the power consumption of the management system can also be reduced as compared with when both of aggregator apparatus 10 and provider apparatus 30 execute the processing of S163. Also, in S163, the first execution transaction data is not transmitted to purchaser apparatus 20 that does not own first distributed ledger 111. With this configuration, the processing of transmitting the first execution transaction data can be omitted, and thus the amount of processing by the processor of the management system can be reduced, and the power consumption of the management system can also be reduced.

Next, each of aggregator apparatus 10 and provider apparatus 30 executes a consensus algorithm to generate a block that includes the first execution transaction data, and stores the generated block in first distributed ledger 111 (S164).

Next, when the consensus algorithm has been executed on the first execution transaction data, each of aggregator apparatus 10 and provider apparatus 30 executes a first payment smart contract (S165). Specifically, each of aggregator apparatus 10 and provider apparatus 30 transfers at least a portion of the value for the data from the account held by the aggregator to the account held by the provider (S165). As described above, aggregator apparatus 10 and provider apparatus 30 that each own first distributed ledger 111 execute the processing of S162, S163, S164, and S165. On the other hand, purchaser apparatus 20 that does not own first distributed ledger 111 does not execute the processing of S162, S163, S164, and S165, and thus the amount of processing by the processor of the management system can be reduced. With this configuration, the power consumption of the management system can be reduced.

### Embodiment 3

Embodiment 3 is different from Embodiment 1 in that data buy-sell processing performed by a management system according to Embodiment 3 is partially changed. The configuration of the management system of the present embodiment is the same as that of the management system of Embodiment 1. Accordingly, a description thereof is omitted here. In Embodiment 3, aggregator apparatus 10 may incorporate a first payment smart contract ID identified when generating a second payment smart contract in the second payment smart contract generated. Also, in Embodiment 3, it is assumed that each distributed ledger information is stored in the second payment blockchain of second distributed ledger 112.

FIG. 13 is a sequence diagram illustrating an example of data buy-sell processing performed by the management system according to Embodiment 3.

Purchaser apparatus 20 references a database that includes a list of data to be traded, and designates data to be purchased (S171).

Purchaser apparatus 20 generates purchase transaction data that includes information that indicates the data to be purchased and a value for the data (S172).

Purchaser apparatus 20 transmits the generated purchase transaction data to aggregator apparatus 10 (S173).

Next, each of aggregator apparatus 10 and purchaser apparatus 20 executes a consensus algorithm to generate a block that includes the purchase transaction data, and stores the generated block in second distributed ledger 112 (S174).

Next, when the consensus algorithm has been executed on the purchase transaction data, each of aggregator apparatus 10 and purchaser apparatus 20 executes a second smart contract (S175 to S177).

Next, each of aggregator apparatus 10 and purchaser apparatus 20 transfers the value for the data from the account held by the purchaser to the account held by the aggregator (S175).

Next, each of aggregator apparatus 10 and purchaser apparatus 20 determines whether the apparatus holds first distributed ledger 111 (S176). Specifically, each of aggregator apparatus 10 and purchaser apparatus 20 determines whether the apparatus holds first distributed ledger 111 based on the distributed ledger information stored in second distributed ledger 112. Because aggregator apparatus 10 holds first distributed ledger 111, Yes is determined, and aggregator apparatus 10 performs the next step (step S177). Purchaser apparatus 20, on the other hand, does not hold first distributed ledger 111, and thus, No is determined, and the processing ends.

Next, aggregator apparatus 10 generates first execution transaction data for invoking a first payment smart contract (S177). The first execution transaction data includes a first payment smart contract ID for identifying the first payment smart contract. Purchaser apparatus 20 does not execute the processing of S177 because purchaser apparatus 20 does not own first distributed ledger 111. With this configuration, the amount of processing by the processor of the management system and the power consumption of the management system can be reduced.

Next, aggregator apparatus 10 transmits the first execution transaction data to provider apparatus 30 that owns first distributed ledger 111 that stores the first payment smart contract (S178).

Next, each of aggregator apparatus 10 and provider apparatus 30 executes a consensus algorithm to generate a block that includes the first execution transaction data, and stores the generated block in first distributed ledger 111 (S179).

Next, when the consensus algorithm has been executed on the first execution transaction data, each of aggregator apparatus 10 and provider apparatus 30 executes a first payment smart contract (S180). Specifically, each of aggregator apparatus 10 and provider apparatus 30 transfers at least a portion of the value for the data from the account held by the aggregator to the account held by the provider (S180).

As described above, aggregator apparatus 10 generates first execution transaction data for executing a first payment smart contract during execution of the second payment smart contract (S177). Aggregator apparatus 10 records the generated first execution transaction data in a first payment blockchain (S179), and thereby executes the first payment smart contract (S180).

Accordingly, by executing the second payment smart contract, aggregator apparatus 10 can execute the first payment smart contract. That is, aggregator apparatus 10 can jointly execute the first payment smart contract and the second payment smart contract without having to executing an association smart contract as in Embodiment 1.

Also, the second payment smart contract includes an identifier for identifying the first payment smart contract, or in short, a first payment smart contract ID. Aggregator apparatus 10 references the first payment smart contract ID to identify a first payment smart contract that is correlated with the second payment smart contract, and generates first execution transaction data after the first payment smart contract has been identified during execution of the second payment smart contract.

With this configuration, aggregator apparatus 10 can easily identify the first payment smart contract that is jointly executed with the second payment smart contract.

### Embodiment 4

Embodiment 4 is different from Embodiment 1 in that data buy-sell processing performed by a management system according to Embodiment 4 is partially changed. The configuration of the management system of the present embodiment is the same as that of the management system of Embodiment 1. Accordingly, a description thereof is omitted here.

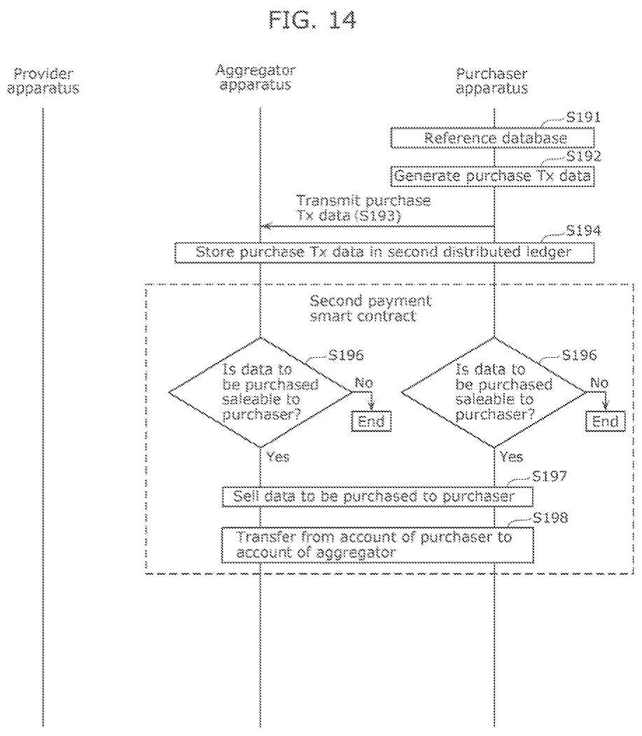

FIG. 14 is a sequence diagram illustrating an example of data buy-sell processing performed by the management system according to Embodiment 4.

Purchaser apparatus 20 references a database that includes a list of data to be traded, and designates data to be purchased (S191).

Purchaser apparatus 20 generates purchase transaction data that includes information that indicates the data to be purchased and a value for the data (S192).

Purchaser apparatus 20 transmits the generated purchase transaction data to aggregator apparatus 10 (S193).

Next, each of aggregator apparatus 10 and purchaser apparatus 20 executes a consensus algorithm to generate a block that includes the purchase transaction data, and stores the generated block in second distributed ledger 112 (S194). Next, when the consensus algorithm has been executed on the purchase transaction data, each of aggregator apparatus 10 and purchaser apparatus 20 executes a second smart contract (S195 to S198).

Next, each of aggregator apparatus 10 and purchaser apparatus 20 determines whether the data to be purchased that was designated by the purchase transaction data can be sold to the purchaser (S196). Each of aggregator apparatus 10 and purchaser apparatus 20 compares a provider attribute with a purchaser attribute. If it is determined that the provider attribute and the purchaser attribute satisfy a predetermined relationship, each of aggregator apparatus 10 and purchaser apparatus 20 determines that the data to be purchased can be sold to the purchaser. If it is determined that the provider attribute and the purchaser attribute do not satisfy the predetermined relationship, each of aggregator apparatus 10 and purchaser apparatus 20 determines that the data to be purchased cannot be sold to the purchaser. As used herein, the term “predetermined relationship” means that the provider attribute and the purchaser attribute are not similar, specifically, for example, the residential location of the provider and the residential location of the purchaser are distant from each other by a predetermined distance or more.

If it is determined that the data to be purchased designated by the purchase transaction data can be sold to the purchaser (Yes in S196), each of aggregator apparatus 10 and purchaser apparatus 20 executes step S197. If it is determined that the data to be purchased designated by the purchase transaction data cannot be sold to the purchaser (No in S196), each of aggregator apparatus 10 and purchaser apparatus 20 ends the processing.

In step S197, aggregator apparatus 10 provides the data to be purchased to the purchaser (S197). Specifically, aggregator apparatus 10 may transmit the data to be purchased to purchaser apparatus 20, or may access a database in which the data to be purchased is stored, and transmit information required to download the data to be purchased to purchaser apparatus 20.

Next, each of aggregator apparatus 10 and purchaser apparatus 20 transfers the value for the data from the account held by the purchaser to the account held by the aggregator (S198).

### Other Embodiments, etc.

Up to here, the present disclosure has been described based on the embodiments given above. However, the present disclosure is of course not limited to the embodiments given above. The following configurations are also encompassed in the scope of the present disclosure.

(1) Each device used in the embodiments given above specifically, a computer system that includes a microprocessor, a ROM, a RAM, a hard disk unit, a display unit, a keyboard, a mouse, and the like. A computer program is recorded in the RAM or the hard disk unit. The functions of each device are implemented as a result of the microprocessor operating in accordance with the computer program. Here, the computer program is composed of a combination of a plurality of instruction codes that indicate instructions for a computer to achieve predetermined functions.

(2) Some or all of the structural elements that constitute each device used in the embodiments given above may be composed of a single system LSI (Large Scale Integration). The system LSI is a super multifunctional LSI manufactured by integrating a plurality of structural elements on a single chip, and is specifically a computer system that includes a microprocessor, a ROM, a RAM, and the like. A computer program is recorded in the RAM. The functions of the system LSI are implemented as a result of the microprocessor operating in accordance with the computer program.

Also, the structural elements that constitute each device described above may be individual single chips, or a part or all of them may be configured in a single chip.

Also, a system LSI is used here, but the LSI may be called IC, LSI, super LSI, or ultra LSI according to the degree of integration. Also, implementation of an integrated circuit is not limited to an LSI, and may be realized by a dedicated circuit or a general-purpose processor. It is also possible to use an FPGA (Field Programmable Gate Array) that can be programmed after LSI production or a reconfigurable processor that enables reconfiguration of the connection and setting of circuit cells in the LSI.

Furthermore, if a technique for implementing an integrated circuit that can replace LSIs appears by another technique resulting from the progress or derivation of semiconductor technology, functional blocks may be integrated by using that technique. Application of biotechnology or the like is possible.

(3) Some or all of the structural elements that constitute each device described above may be composed of an IC card or a single module that is detachable from the device. The IC card or the module is a computer system that includes a microprocessor, a ROM, a RAM, and the like. The IC card or the module may include a super multifunctional LSI that was described above. The functions of the IC card or the module are implemented as a result of the microprocessor operating in accordance with a computer program. The IC card or the module may be tamper resistant.

(4) The present disclosure may be any of the methods described above. Alternatively, the present disclosure may be a computer program that implements any of the methods by using a computer, or may be a digital signal generated by the computer program.

Also, the present disclosure may be implemented by recording the computer program or the digital signal in a computer readable recording medium such as, for example, a flexible disk, a hard disk, a CD-ROM, a MO, a DVD, a DVD-ROM, a DVD-RAM, a BD (Blu-ray (registered trademark) Disc), or a semiconductor memory. Also, the present disclosure may be the digital signal recorded in the recording medium.

Also, the present disclosure may be implemented by transmitting the computer program or the digital signal via a telecommunication line, a wireless or wired communication line, a network as typified by the Internet, data broadcasting, or the like.

Also, the present disclosure may be a computer system that includes a microprocessor and a memory. The above-described computer program may be recorded in the memory, and the microprocessor may operate in accordance with the computer program.

Also, the present disclosure may be implemented by another independent computer system by recording the program or the digital signal on the recording medium to transfer the program or the digital signal, or by transferring the program or the digital signal via the network or the like.

(5) The embodiments and variations given above may be combined.

### INDUSTRIAL APPLICABILITY

The present disclosure is applicable to a method, a server, or a program. For example, the present disclosure is applicable to a method, an apparatus, a program, or the like with which it is possible to jointly execute two types of value transfer contracts.

1. A method comprising:
acquiring transaction data that includes value information regarding a value to be transferred from a second user to a first user;
executing a first smart contract recorded in a first blockchain by recording the transaction data in the first blockchain; and
executing a second smart contract recorded in a second blockchain different from the first blockchain based on the first smart contract,
wherein the second smart contract is a smart contract for transferring at least a portion of the value to be transferred from the second user to the first user, from a first account held by the first user to a third account held by a third user.

2. The method according to claim 1,
wherein the executing of the first smart contract includes:
generating first execution transaction data for executing the second smart contract; and
the executing of the second smart contract includes recording the first execution transaction data generated in the second blockchain.

3. The method according to claim 1,
wherein the executing of the first smart contract includes:
generating second execution transaction data for executing a third smart contract recorded in a third blockchain different from the first blockchain and the second blockchain; and
executing the third smart contract by recording the second execution transaction data in the third blockchain.

4. The method according to claim 3,
wherein the executing of the third smart contract includes:
identifying the second smart contract that is a smart contract correlated with the first smart contract;
generating first execution transaction data for executing the second smart contract; and
the executing of the second smart contract includes recording the first execution transaction data in the second blockchain.

5. The method according to claim 1,
wherein the executing of the first smart contract includes:
transferring the value to be transferred from the second user to the first user, from a second account held by the second user to the first account held by the first user.

6. The method according to claim 2,
wherein the first smart contract includes an identifier for identifying the second smart contract, and
the executing of the first smart contract includes:
identifying the second smart contract that is correlated with the first smart contract by referencing the identifier; and
generating the first execution transaction data after the identifying.

7. The method according to claim 1,
wherein the executing of the first smart contract includes:
determining whether a first apparatus holds the second blockchain, the first apparatus holding distributed ledgers that use blockchains, and
executing the second smart contract when the first apparatus is determined to hold the second blockchain.

8. The method according to claim 1,
wherein the value to be transferred from the second user to the first user is a value for data that is provided from the third user,
the data is stored publicly in association with a converted identifier obtained as a result of converting an identifier for identifying the third user, and
the identifier for identifying the third user is stored privately in association with the converted identifier.

9. An apparatus comprising:
an acquirer that acquires transaction data that includes value information regarding a value to be transferred from a second user to a first user; and
an executor that (i) executes a first smart contract recorded in a first blockchain by recording the transaction data in the first blockchain and (ii) executing a second smart contract recorded in a second blockchain different from the first blockchain based on the first smart contract,
wherein the second smart contract is a smart contract for transferring at least a portion of the value to be transferred from the second user to the first user, from a first account held by the first user to a third account held by a third user.

10. A non-transitory computer-readable recording medium having recorded thereon a program for causing a computer to execute a method for controlling an apparatus, the method comprising:
acquiring transaction data that includes value information regarding a value to be transferred from a second user to a first user;
executing a first smart contract recorded in a first blockchain by recording the transaction data in the first blockchain; and
executing a second smart contract recorded in a second blockchain different from the first blockchain based on the first smart contract,
wherein the second smart contract is a smart contract for transferring at least a portion of the value to be transferred from the second user to the first user, from a first account held by the first user to a third account held by a third user.
